(19) United States
(12) Patent Application Publication
(10) Pub. No.: US 2005/0272483 A1
(43) Pub. Date: Dec. 8, 2005

(54) Electronic device

(75) Inventors: Ti-Chieh Ko, Taipei City (TW); Fu-Long Hong, Banciao City (TW); Hsiu-Wei Ye, Wufong Township (TW); Hsun-Li Huang, Hsinchu City (TW); Yu-Fen Lo, Yonghe City (TW)

Correspondence Address: BIRCH STEWART KOLASCH & BIRCH, PO BOX 747, FALLS CHURCH, VA, 22040-0747, US

(73) Assignee: BENQ Corporation, Bueishan (TW)

(21) Appl. No.: 11/139,616

(22) Filed: May 31, 2005

(30) Foreign Application Priority Data
Jun. 1, 2004 (TW) 093115623

(51) Int. Cl. G05D 1/00; B64C 1/00; G06F 17/00; G05D 3/00; G06F 7/00; H04M 1/00; H02B 1/01

(52) U.S. Cl. 455/575.1

(57) ABSTRACT

An electronic device. A body has an engaging portion. A frame is hinged to the body, rotatable between a first position and a second position. The frame comprises a recess. The engaging portion is disposed in the recess and engages the body and the frame, disposing the frame in the first position, substantially parallel to the body. When the frame is in the second position, the body and the frame form a first angle.

### BACKGROUND

The invention relates to an electronic device, and in particular to a scanner.

Scanners are often used in on an office or home work area such as a desktop. Other devices such as displays and printers may also be put in the same space; however, the scanner's large planar area can occupy too much workable space.

### SUMMARY

Embodiments of the invention provide an electronic device that can be deployed in various orientations, comprising a body and a frame. The body comprises an engaging portion. The frame is hinged to the body, rotatable between a first position and a second position. The frame comprises a recess. The engaging portion is disposed in the recess to engage the body and the frame such that the frame is in the first position, substantially parallel to the body. When the frame is in the second position, the body and the frame form a first angle.

Further provided is another electronic device, in which a body comprises a first edge. A frame is hinged to the body, comprising a second edge and a third edge, substantially parallel to the first edge, and the frame is rotatable between a first position and a second position; when the frame is in the first position, the first edge contacts the second edge such that the frame is substantially parallel to the body; and when the frame is in the second position, the electronic device is supported on a surface via the first edge of the body and the third edge of the frame.

### BRIEF DESCRIPTION OF THE DRAWINGS

The invention can be more fully understood by reading the subsequent detailed description in conjunction with the examples and references made to the accompanying drawings, wherein:

FIG. 1A is a perspective view of an electronic device in a first position according to a first embodiment of the invention;

FIG. 1B is a perspective view of the electronic device in the first position when the cover is open according to the first embodiment of the invention;

FIG. 2A is a perspective view of the electronic device hung vertically according to the first embodiment of the invention;

FIG. 2B is a rear view of the electronic device in the first position according to the first embodiment of the invention;

FIG. 3A is a perspective view of an electronic device in a second position according to the first embodiment of the invention;

FIG. 3B is a schematic rear view of an electronic device in the second position according to the first embodiment of the invention;

FIG. 3C is a perspective view of a frame of the electronic device according to the first embodiment of the invention;

FIG. 3D is a schematic side view of the electronic device in the first position according to the first embodiment of the invention;

FIG. 3E is a schematic side view of the electronic device in the second position according to the first embodiment of the invention;

FIG. 4A is a perspective view of an electronic device in a first position according to a second embodiment of the invention;

FIG. 4B is a perspective view of the electronic device in a second position according to the second embodiment of the invention;

FIG. 4C is a schematic side view of the electronic device in the first position according to the second embodiment of the invention;

FIG. 4D is a schematic side view of a frame of the electronic device in transition according to the second embodiment of the invention; and

FIG. 4E is a schematic side view of the electronic device in the second position according to the second embodiment of the invention.

### DETAILED DESCRIPTION

While electronic devices 10, 20 disclosed in embodiments of the invention are scanners, the characteristics of the embodiments are applicable in other electronic devices such as flat panel displays, lightweight copiers, multifunction printers, notebook computers, and other devices.

### First Embodiment

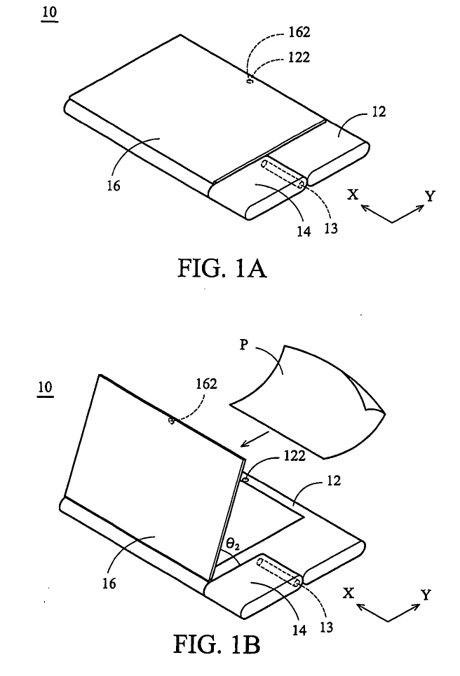

FIG. 1A is a perspective view of an electronic device 10 in a first position according to a first embodiment of the invention. FIG. 1B is a perspective view of the electronic device 10 in the first position when a cover 16 is open.

The electronic device 10 comprises a body 12, a frame 14, a shaft 13, and the cover 16. The frame 14 is hinged to the body 12 via the shaft 13. When the cover 16i is closed on the frame 14, the position is defined as a first position.

When the frame 14 is in the first position, the electronic device 10 can be laid flat on a plane XY, as shown in FIGS. 1A and 1B. In this position, the frame 14 and the body 12 are substantially parallel. The cover 16 is movable connected to the body 12, partially covering the body 12. The body 12 comprises a first magnetic element 122, and the cover 16 comprises a second magnetic element 162. The cover 16 and the body 12 maintain proximity by magnetic attraction between the first magnetic element 122 and the second magnetic element 162. Thus, the cover 16 can contact the body 12 or separate therefrom.

When the cover 16 is separated from the body 12, paper P can be disposed therebetween for scanning. When the cover 16 is open, the cover 16 and the body 12 form an angle θ₂, less than 90°.

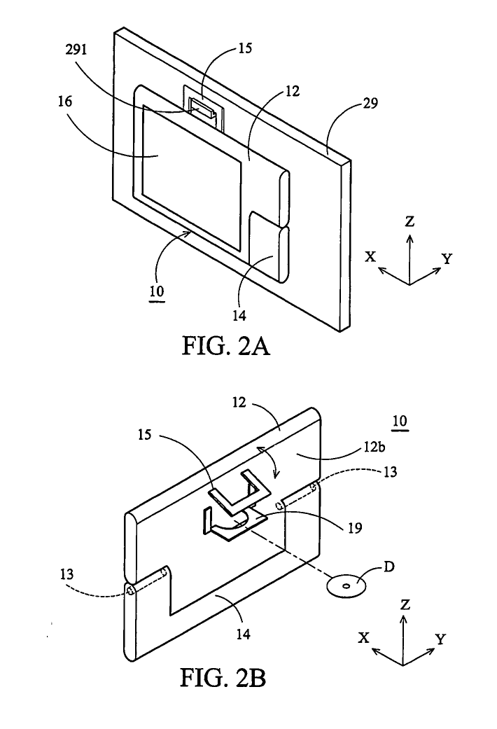

FIG. 2A is a perspective view of the electronic device 10 hung vertically according to the first embodiment of the invention. When the frame 14 is in the first position, it can be hung on a vertical surface 29. That is, when the frame 14 is close to the body 12, the electronic device 10 can be substantially vertically hung on a hook 291 of the vertical surface 29 via a handle 15, allowing scanning of paper P without occupying any horizontal workspace.

Furthermore, FIG. 2B is a rear view of the electronic device 10 in the first position. Handle 15 is rotatably disposed on the rear 12b of the body 12. The rear 12b of the body 12 comprises a containing portion 19 for any circular element D such as a compact disk (CD).

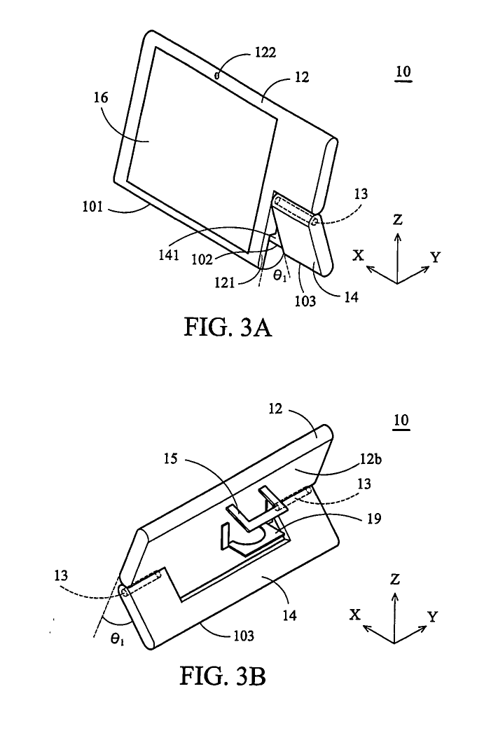

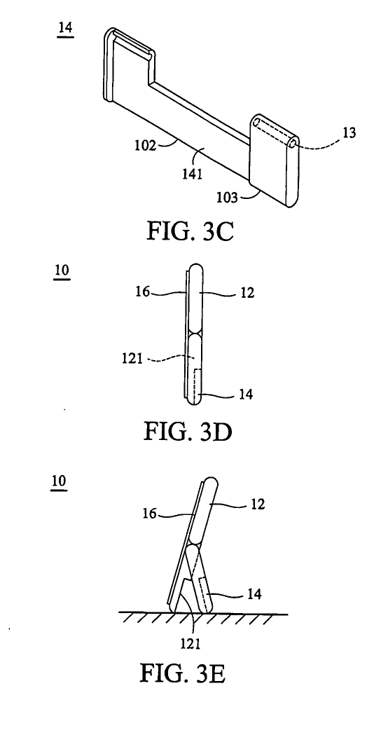

FIG. 3A is a perspective view of the electronic device 10 in a second position according to the first embodiment of the invention. FIG. 3B is a schematic rear view of the electronic device 10 in the second position.

As mentioned, the frame 14 is hinged to the body 12 via the shaft 13, movable between the first position (FIG. 1A) and the second position (FIG. 3A). The second position is upright. When the frame 14 is in the second position, the frame 14 and the body 12 act as a stand, forming an angle θ₁ therebetween, variable according to application.

Furthermore, the body 12 comprises an engaging potion 121. FIG. 3C is a perspective view of the frame 14 of the electronic device 10. The frame 14 comprises a recess 141. When the frame 14 is in the first position, the recess 141 corresponding to the engaging portion 121 is engaged by the engaging portion 121 such that the body 12 is substantially parallel to the frame 14. Thus, the electronic device 10 can be placed on the plane XY with engaging portion 121 acting as a support for the body 12. Thus, the frame 14 and the engaging portion 121 simultaneously support the electronic device 10 in upright position.

Moreover, the body 12 comprises a first edge 101, with engaging portion 121 located thereon. The frame comprises a second edge 102 and a third edge 103. The recess 131 is located on the second edge 102. When the frame 14 is in the first position, the first edge 101 contacts the second edge 102 such that the engaging portion 121 is disposed in the recess 141, and the frame 14 is substantially parallel to the body 12. Thus, the electronic device 10 can be deployed on plane XY. When the frame 14 is in the second position, the electronic device 10 is supported on a surface via the first edge 101 of the body 12 and the third edge 103 of the frame 14.

FIGS. 3D and 3E are schematic side views of the electronic device 10, showing transition between the first and the second positions. When the frame 14 is in the first position, as shown in FIG. 3D, the body 12 and the frame 14 are linearly aligned, and the engaging portion 121 is contained in the recess 141 of the frame 14.

Note that the recess 141 concealed by the engaging portion 121, upon separation is revealed. The frame 14 is in the first position when the engaging portion 121 of the body 12 is engaged with the recess 141.

When the frame 14 is in the second position, as shown in FIG. 3E, the frame 14 and the body 12 provide support on the same plane such that the electronic device 10 is upright.

### Second Embodiment

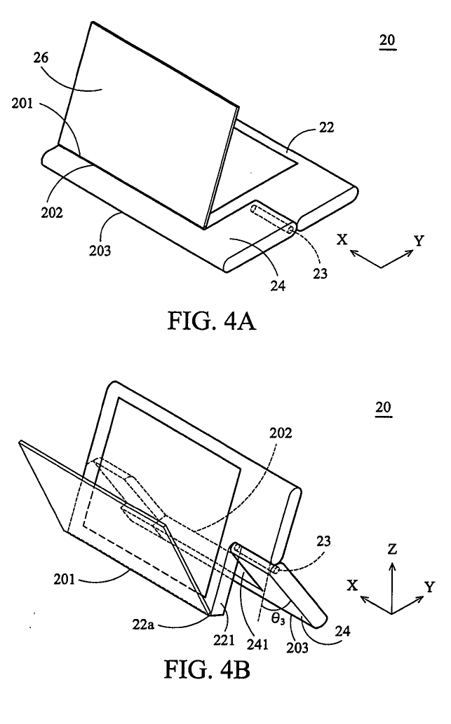

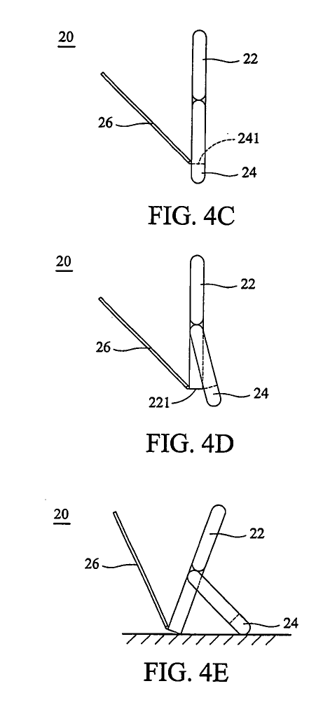

FIG. 4A is a perspective view of an electronic device 20 in a first position according to a second embodiment of the invention. FIG. 4B is a perspective view of the electronic device 20 in the second position.

The electronic deice 20 comprises a body, a frame 24, and a cover 26. The body 22 comprises a first edge 201 and an engaging portion 221 located thereon. The frame 24, rotatably hinged to the body 22 via a shaft 23, comprises a recess 241, a second edge 202, and a third edge 203, parallel to the first edge 201. The recess 241 is located on the second edge 202. The cover 26 is hinged to a side 22a of the body 22 near the first edge 201. The cover 26 can contact or separate from the body 22 via magnetic elements (not shown) similar to the first embodiment.

When the cover 26 moves in a first direction shown by arrow A to separate from the body 22, a paper can be inserted for scanning.

The frame 24 can be rotatable from a first position (FIG. 4A) and a second position (FIG. 4B). When the frame 24 is in the first position, the first edge 201 contacts the second edge 202 such that the frame 24 is substantially parallel to the body 22. The engaging portion 221 is engaged with the recess 241, and thus, the electronic device 20 can be supported on a plane XY.

When the frame 24 moves in a second direction shown by arrow B, the electronic device or scanner 20 is upright, supported by the first edge 201 and the third edge 203 on plane XY. When the electronic device 20 is positioned upright, the body 22 and the frame 24 form an angle θ₃, variable with requirement. Note that directions A and B are opposite.

When the frame 24 is in the first position, as shown in FIG. 4C, observed from a side thereof, the frame 24 and the body 22 are aligned. The engaging portion 221 of the body 22 is engaged with the recess 241.

When the electronic device 20 is deployed in upright position, as shown in FIG. 4D, the frame 24 is moved to separate from the engaging portion 221 of the body 22.

When the electronic device 20 is rotated to the second position, as shown in 4E, the frame 24 and the engaging portion 221 simultaneously support the body 22 on the same plane.

In conclusion, in embodiments of the invention, the electronic device can be deployed in various orientations.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electronic device, comprising:
a body, comprising an engaging portion; and
a frame, hinged to the body, rotatable between a first position and a second position, comprising a recess, wherein the engaging portion disposed in the recess to engage the body and the frame disposes the frame in the first position; wherein the frame is substantially parallel to the body; and when the frame is in the second position, the body and the frame form a first angle.

2. The electronic device as claimed in claim 1, further comprising a shaft, connecting the frame and the body.

3. The electronic device as claimed in claim 1, further comprising a cover, movably connected to the body and covering at least a portion of the body.

4. The electronic device as claimed in claim 3, wherein the cover is contact with or separated from the body selectively, and when the cover is separated from the body, the cover and the body form a second angle less than 90°.

5. The electronic device as claimed in claim 4, wherein the body further comprises a first magnetic element; the cover further comprises a second magnetic element, and the cover and the body attach together by the first magnetic element and the second magnetic element.

6. The electronic device as claimed in claim 1, further comprising a handle, rotatably disposed on the body; wherein when the frame is in the first position, the electronic device is substantially vertically deployed by means of the handle.

7. The electronic device as claimed in claim 1, wherein body further comprises a containing portion, containing a circular object.

8. The electronic device as claimed in claim 1, wherein the electronic device comprises a scanner.

9. An electronic device, comprising:
a body, comprising a first edge; and
a frame, hinged to the body, comprising a second edge and a third edge substantially parallel to the first edge, the frame rotatable between a first position and a second position; wherein when the frame is in the first position, the first edge contacts the second edge, substantially parallel to the body; and when the frame is in the second position, the electronic device is upright on a flat surface by support of the first edge of the body and the third edge of the frame.

10. The electronic device as claimed in claim 9, further comprising a cover, hinged to the body and selectively contacting or separated from the body; whereby when the cover moves in a first direction, the cover separates from the body, and when the cover moves in a second direction to the second position, wherein the first direction is opposite to the second direction.

11. The electronic device as claimed in claim 10, wherein the cover is hinged to a side of the body in the vicinity of the first edge.

12. The electronic device as claimed in claim 9, wherein the body further comprises an engaging portion, the frame further comprises a recess, and when the frame is in the first position, the engaging portion is engaged with the recess.
